(19) United States
(12) Patent Application Publication
(10) Pub. No.: US 2024/0395069 A1
(43) Pub. Date: Nov. 28, 2024

(54) DEEP VIDEO LINKAGE FEATURE-BASED BEHAVIOR RECOGNITION METHOD

(71) Applicant: SOOCHOW UNIVERSITY, Jiangsu (CN)

(72) Inventors: Jianyu YANG, Jiangsu (CN); Yao HUANG, Jiangsu (CN)

(21) Appl. No.: 18/685,227

(22) PCT Filed: Jun. 14, 2022
(86) PCT No.: PCT/CN2022/098508

§ 371 Date: Feb. 20, 2024

(30) Foreign Application Priority Data
Aug. 23, 2021 (CN) 202110968288.1

(51) Int. Cl. G06V 40/20; G06V 10/50; G06V 10/774; G06V 10/82

(52) U.S. Cl. CPC G06V 40/28; G06V 10/50; G06V 10/774; G06V 10/82

(57) ABSTRACT

Provided relates to a depth video linkage feature-based behavior recognition method, comprising projecting a depth video of each behavior sample onto a front-side, a right-side, a left-side and a top-side; obtaining a dynamic image of each behavior sample by calculating a dynamic image of each projection sequence; inputting the dynamic image of each behavior sample into a respective feature extraction module and extracting features; inputting the extracted features into a multi-projection linkage feature extraction module and extracting a linkage feature of each projection combination; connecting all the extracted linkage features by channel, and inputting the connected features into an average pooling layer and a fully connected layer; constructing a depth video linkage feature-based behavior recognition network; inputting a depth video of each training behavior sample into the depth video linkage feature-based behavior recognition network, and training the network till convergence; and inputting a depth video of each behavior sample.

### TECHNICAL FIELD

The present invention relates to the field of computer vision technologies, in particular to a depth video linkage feature-based behavior recognition method.

### BACKGROUND

Behavior recognition, which is now a research hotspot in the field of computer vision, is widely used in the fields of video surveillance, behavior analysis and the like.

With the development of depth cameras, depth videos, including a great deal of motion information, are readily accessible to people. Some scholars acquire locations of human bone joints in a depth video and use data of the joints for recognition. Other scholars directly input the depth video into a network for behavior recognition. However, the bone joint-based behavior recognition is susceptible to not only the accuracy in acquiring the bone joints but also intra-class differences of behaviors and the occlusion of the bone joints. Directly inputting the depth video into the network fails to make full use of three-dimensional information contained in the depth video and a feature relationship between behaviors in different dimensions.

Therefore, a depth video linkage feature-based behavior recognition method is provided to solve the problems of the behavior recognition algorithms described above.

### SUMMARY

The present invention is provided to solve the problems in the prior art, and its objective is to provide a depth video linkage feature-based behavior recognition method, so as to solve the problem that deep features extracted by an existing recognition method fail to make full use of three-dimensional information in a depth behavior video.

The depth video linkage feature-based behavior recognition method includes the following steps:
1) projecting a depth video of each behavior sample onto a front side, a right side, a left side and a top side to obtain corresponding projection sequences;
2) obtaining a dynamic image of each behavior sample by calculating a dynamic image of each projection sequence;
3) inputting the dynamic image of each behavior sample into a respective feature extraction module and extracting features;
4) inputting the extracted features into a multi-projection linkage feature extraction module and extracting a linkage feature of each projection combination;
5) connecting the extracted linkage features of all projection combinations by channel, and inputting the connected features into an average pooling layer and a fully connected layer;
6) constructing a depth video linkage feature-based behavior recognition network;
7) inputting a depth video of each training behavior sample into the depth video linkage feature-based behavior recognition network, and training the network till convergence; and
8) inputting a depth video of each behavior sample to be tested into the trained depth video linkage feature-based behavior recognition network to implement behavior recognition.

Preferably, the projection sequence is obtained in step 1) as follows:
acquiring a depth video of any behavior sample, each behavior sample consisting of all frames in the depth video of the behavior sample,

$$V = \{ {I}_{t} \vert t ∈ [ 1 , N ] \} ,$$

in which t represents a time index, and N is a total quantity of frames of the depth video V of the behavior sample. Iₜ∈R×C is a matrix representation of a t^{th}-frame depth image of the depth video V of the behavior sample, in which R and C correspond to the quantity of rows and the quantity of columns of the matrix representation of the t^{th}-frame depth image respectively, and indicates that a matrix is a real matrix. Iₜ(xᵢ, yᵢ)=dᵢ represents a depth value of a point pᵢ with coordinates (xᵢ, yᵢ) on the t^{th}-frame depth image, i.e., a distance between the point pᵢ and a depth camera. dᵢ∈[0, D], in which D represents the furthest distance detectable by the depth camera.

The depth video V of the behavior sample can be expressed as a set of projection sequences, which is denoted by a formula:

$$V = \{ {V}_{front} , {V}_{right} , {V}_{left} , {V}_{top} \} ,$$

in which V_{front} represents a projection sequence obtained by projecting the depth video V of the behavior sample onto a front side, V_{right} represents a projection sequence obtained by projecting the depth video V of the behavior sample onto a right side, V_{left} represents a projection sequence obtained by projecting the depth video V of the behavior sample onto a left side, and the Vₜₒₚ represents a projection sequence obtained by projecting the depth video V of the behavior sample onto a top side.

The projection sequence V_{front} is acquired as follows:

V_{front}={Fₜ|t∈[1, N]}, in which Fₜ∈R×C represents a projection graph obtained by projecting the t^{th}-frame depth image of the depth video V of the behavior sample onto a front side. An abscissa value, xᵢ, an ordinate value yᵢ and a depth value dᵢ of the point pᵢ in the depth image respectively determine an abscissa value xᵢ^{ƒ}, an ordinate value yᵢ^{ƒ} and a pixel value zᵢ^{ƒ} of a point projected from the point pᵢ onto the projection graph Fₜ, which are denoted by formulas:

$${F}_{t} ( {x}_{i}^{f} , {y}_{i}^{f} ) = {z}_{i}^{f} , \\ {x}_{i}^{f} = {x}_{i} , {y}_{i}^{f} = {y}_{i} , {z}_{i}^{f} = {f}_{1} ( {d}_{i} ) ,$$

in which ƒ₁ is a linear function indicating that the depth value dᵢ is mapped to an interval [0,255], such that the smaller the depth value of a point is, the larger the pixel value of the point on the projection graph is, i.e., the closer the point is to the depth camera, the brighter the point is on a front-side projection graph.

The projection sequence V_{right} is acquired as follows:

V_{right}={Rₜ|t∈[1, N]}, in which Rₜ∈R×D represents a projection graph obtained by projecting the t^{th}-frame depth image on a right side. At least one point is projected onto the same location on the projection graph when the depth image is projected onto the right side. A point closest to an observer, i.e., a point furthest from a projection plane, can be seen when a behavior is observed from the right side. An abscissa value of the point, furthest from the projection plane, on the depth image is reserved, and a pixel value of the point in this location of the projection graph is calculated according to the abscissa value. Points in the depth image are traversed column by column from a column with the smallest abscissa x on the depth image in a direction in which x increases, and are projected onto the projection graph. An abscissa value xᵢ, an ordinate value yᵢ and a depth value dᵢ of the point pᵢ in the depth image respectively determine a pixel value zᵢ^{r}, an ordinate value yᵢ^{r} and an abscissa value xᵢ^{r} of a point in a projection graph Rₜ, which are denoted by formulas:

$${F}_{t} ( {x}_{i}^{r} , {y}_{i}^{r} ) = {z}_{i}^{r} , \\ {x}_{i}^{r} = {x}_{i} , {y}_{i}^{r} = {y}_{i} , {z}_{i}^{r} = {f}_{2} ( {x}_{i} ) ,$$

in which ƒ₂ is a linear function indicating that the abscissa value xᵢ is mapped to an interval [0,255]. In a case that x continues to increase, a new point is reserved if the new point and the previously projected point are projected onto the same location in the projection graph, i.e., a pixel value of this location in the projection graph is calculated by using the abscissa value of the point with the largest abscissa value, i.e., zᵢ^{r}=ƒ₂(xₘ), in which xₘ=max xᵢ, xᵢ∈X_{R}, X_{R} is a set of abscissas of all points with ordinate values yᵢ^{r} and depth values xᵢ^{r} in the depth image, and max xᵢ, xᵢ∈X_{R} represents a maximum abscissa value in the set X_{R}.

The projection sequence V_{left} is acquired as follows:

V_{left}={Lₜ|t∈[1, N]}, in which Lₜ∈R×D: represents a projection graph obtained by projecting the t^{th}-frame depth image onto a left side. In a case that multiple points are projected onto the same location on a left-side projection graph, a point furthest from the projection plane is reserved. Points in the depth image are traversed column by column from a column with the largest abscissa x on the depth image in a direction in which x decreases, and are projected onto the left-side projection graph. An abscissa value xᵢ, an ordinate value yᵢ and a depth value dᵢ of the point pᵢ in the depth image respectively determine a pixel value zᵢ^{l}, an ordinate value yᵢ^{l} and an abscissa value xᵢ^{l} of a point in the projection graph Lₜ. For a point projected onto the same coordinates (xᵢ^{l}, yᵢ^{l}) on the left-side projection graph, an abscissa value of the point with the smallest abscissa is selected to calculate a pixel value at the coordinates of the projection graph, which are denoted by formulas:

$${L}_{t} ( {x}_{i}^{l} , {y}_{i}^{l} ) = {z}_{i}^{l} , \\ {x}_{i}^{l} = {d}_{i} , {y}_{i}^{l} = {y}_{i} , {z}_{i}^{l} = {f}_{3} ( {x}_{n} ) ,$$

in which ƒ₃ is a linear function indicating that an abscissa value xₙ is mapped to an interval [0,255], xₙ=min xᵢ, xᵢ∈X_{L}, in which X_{L} is a set of abscissas of all points with ordinate values yᵢ^{l} and depth values xᵢ^{l} in the depth image, and min xᵢ, xᵢ∈X_{L} represents a minimum abscissa value in the set X_{L}.

The projection sequence Vₜₒₚ is acquired as follows:

Vₜₒₚ={Tₜ|t∈[1, N]}, in which Oₜ∈D×C represents a projection graph obtained by projecting the t^{th}-frame depth image onto a top side. In a case that multiple points are projected onto the same location on a top-side projection graph, a point furthest from the projection plane is reserved. Points in the depth image are traversed column by column from a column with the smallest ordinate y on the depth image in a direction in which y increases, and are projected onto the top-side projection graph. An abscissa value xᵢ, an ordinate value yᵢ and a depth value dᵢ of the point pᵢ in the depth image respectively determine an abscissa value xᵢ^{o}, a pixel value zᵢ^{o} and an ordinate value yᵢ^{o} of a point projected from the point pᵢ onto the projection graph Oₜ. For a point projected onto the same coordinates (xᵢ^{o}, yᵢ^{o}) on the projection graph, an ordinate value of the point with the largest ordinate is selected to calculate a pixel value at the coordinates of the projection graph, which is denoted by formulas:

$${O}_{t} ( {x}_{i}^{o} , {y}_{i}^{o} ) = {z}_{i}^{o} , \\ {x}_{i}^{0} = {x}_{i} , {y}_{i}^{o} = {d}_{i} , {z}_{i}^{o} = {f}_{4} ( {y}_{q} ) ,$$

in which ƒ₄ is a linear function indicating that an ordinate value y_{q} is mapped to an interval [0,255], y_{q}=max yᵢ, yᵢ∈Yₒ, in which Yₒ is a set of ordinates of all points with abscissa values xᵢ^{o} and depth values yᵢ^{o} in the depth image, and max yᵢ, yᵢ∈Yₒ represents a maximum ordinate value in the set Yₒ.

Preferably, the dynamic image is calculated in step 2) as follows:
by taking a front-side projection sequence V_{front}={Fₜ|t∈[1, N]} of the depth video V of the behavior sample as an example, vectorizing Fₜ first, i.e., connecting a row vector of Fₜ into a new row vector iₜ;
solving an arithmetic square root of each element in the row vector iₜ to obtain a new vector wₜ, i.e.:

$${w}_{t} = \sqrt{{i}_{t}} ,$$

in which \sqrt{iₜ} indicates to solve an arithmetic square root of each element in the row vector iₜ, and wₜ is denoted by a frame vector of a t^{th}-frame image of the front-side projection sequence V_{front} of the depth video V of the behavior sample;
calculating a feature vector vₜ of the t^{th}-frame image of the front-side projection sequence V_{front} of the depth video V of the behavior sample according to a formula:

$${v}_{t} = \frac{1}{t} {\sum }_{κ = 1}^{t} {w}_{κ} ,$$

in which Σ_{κ=1}^{t} w_{κ} represents summation of frame vectors from a first-frame image to the t^{th}-frame image of the front-side projection sequence V_{front} of the depth video V of the behavior sample;
calculating a score Bₜ of the t^{th}-frame image Fₜ of the front-side projection sequence V_{front} of the depth video V of the behavior sample according to a formula:

$${B}_{t} = {u}^{T} \cdot {v}_{t} ,$$

in which u is a vector of a dimension A, A=R×C, u^{T} represents transposition of the vector u, and u^{T}·vₜ indicates to calculate a dot product of the feature vector vₜ and a vector obtained by transposing the vector u;
calculating a value of u, such that frame images in the front-side projection sequence V_{front} have higher and higher scores from front to back, i.e., the larger the t is, the higher the score Bₜ is, u being calculated by using RankSVM as follows:

$$u = {arg min}_{u} E ( u ) , \\ E ( u ) = \frac{λ}{2} {‖ u ‖}^{2} + \frac{2}{T ( T - 1 )} \times {\sum }_{c > j} max \{ 0 , 1 - {B}_{c} + {B}_{j} \} ,$$

in which

$${arg min}_{u} E ( u )$$

represents u that minimizes the value of E(u), λ is a constant, and ∥u∥² indicates to calculate a sum of squares of each element in the vector u; B_{c} and Bⱼ respectively represent a score of a c^{th}-frame image and a score of a j^{th}-frame image of the front-side projection sequence V_{front} of the depth video V of the behavior sample, and max {0,1−B_{c}+Bⱼ} indicates to choose a larger value of 0 and 1−B_{c}+Bⱼ; and
in response to calculating the vector u by using RankSVM, arranging the vector u in an image form with the same size as Fₜ to obtain u′∈R×C, u′ being a dynamic image of the front-side projection sequence V_{front} of the depth video V of the behavior sample.

Preferably, the feature extraction module includes a convolution unit 1, a convolution unit 2, a convolution unit 3, a convolution unit 4, a convolution unit 5 and a multi-feature fusion unit, wherein outputs of the convolution unit 1, the convolution unit 2, the convolution unit 3, the convolution unit 4 and the convolution unit 5 are sequentially inputted into the multi-feature fusion unit, and a final output of the multi-feature fusion unit is M₆.

The convolution unit 1 includes two convolution layers and one maximum pooling layer. Each convolution layer has 64 convolution kernels, and each convolution kernel has a size of 3×3. A pooling kernel of the maximum pooling layer has a size of 2×2. An output of the convolution unit 1 is C₁.

The convolution unit 2 includes two convolution layers and one maximum pooling layer. Each convolution layer has 128 convolution kernels, and each convolution kernel has a size of 3×3. A pooling kernel of the maximum pooling layer has a size of 2×2. An input of the convolution unit 2 is C₁ and an output thereof is C₂.

The convolution unit 3 includes three convolution layers and one maximum pooling layer. Each convolution layer has 256 convolution kernels, and each convolution kernel has a size of 3×3. A pooling kernel of the maximum pooling layer has a size of 2×2. An input of the convolution unit 3 is C₂ and an output thereof is C₃.

The convolution unit 4 includes three convolution layers and one maximum pooling layer. Each convolution layer has 512 convolution kernels, and each convolution kernel has a size of 3×3. A pooling kernel of the maximum pooling layer has a size of 2×2. An input of the convolution unit 4 is C₃ and an output thereof is C₄.

The convolution unit 5 includes three convolution layers and one maximum pooling layer. Each convolution layer has 512 convolution kernels, and each convolution kernel has a size of 3×3. A pooling kernel of the maximum pooling layer has a size of 2×2. An input of the convolution unit 5 is C4 and an output thereof is C₅.

Inputs of the multi-feature fusion unit are the output C₁ of the convolution unit 1, the output C₂ of the convolution unit 2, the output C₃ of the convolution unit 3, the output C₄ of the convolution unit 4 and the output C₅ of the convolution unit 5. The output C₁ of the convolution unit 1 is inputted into a maximum pooling layer 1 and a convolution layer 1 in the multi-feature fusion unit. A pooling kernel of the maximum pooling layer 1 has a size of 4×4. The convolution layer 1 has 512 convolution kernels, each convolution kernel has a size of 1×1, and an output of the convolution layer 1 is M₁.

The output C₂ of the convolution unit 2 is inputted into a maximum pooling layer 2 and a convolution layer 2 in the multi-feature fusion unit. A pooling kernel of the maximum pooling layer 2 has a size of 2×2. The convolution layer 2 has 512 convolution kernels, each convolution kernel has a size of 1×1, and an output of the convolution layer 2 is M₂.

The output C₃ of the convolution unit 3 is inputted into a convolution layer 3 in the multi-feature fusion unit. The convolution layer 3 has 512 convolution kernels, each convolution kernel has a size of 1×1, and an output of the convolution layer 3 is M₃.

The output C₄ of the convolution unit 4 is inputted into an up-sampling layer 1 and a convolution layer 4 in the multi-feature fusion unit. The convolution layer 4 has 512 convolution kernels, the convolution kernel has a size of 1×1, and an output of the convolution layer 4 is M₄.

The output C₅ of the convolution unit 5 is inputted into an up-sampling layer 2 and a convolution layer 5 in the multi-feature fusion unit. The convolution layer 5 has 512 convolution kernels, each convolution kernel 5 has a size of 1×1, and an output of the convolution layer 5 is M₅. The output M₁ of the convolution layer 1, the output M₂ of the convolution layer 2, the output M₃ of the convolution layer 3, the output M₄ of the convolution layer 4 and the output M₅ of the convolution layer 5 are connected by channel and inputted into a convolution layer 6. The convolution layer 6 bas 256 convolution kernels, each convolution kernel has a size of 1×1, and an output of the convolution layer 6 is M₆. An output of the multi-feature fusion unit is the output M₆ of the convolution layer 6.

Dynamic images of the front-side projection sequence, the right-side projection sequence, the left-side projection sequence and the top-side projection sequence of the depth video V of the behavior sample are respectively inputted into respective feature extraction modules, namely, a front-side projection feature extraction module, a right-side projection feature extraction module, a left-side projection feature extraction module and a top-side projection feature extraction module. During network training, the modules described above do not share parameters. The feature extraction modules described above respectively output features and Q⁷¹ , Q^{r}, Q^{l} and Q^{t}.

Q^{ƒ} represents a feature that is extracted when the dynamic image of the front-side projection sequence of the depth video V of the behavior sample is inputted into the front-side projection feature extraction module; Q^{r} represents a feature that is extracted when the dynamic image of the right-side projection sequence of the depth video V of the behavior sample is inputted into the right-side projection feature extraction module; Q^{l} represents a feature that is extracted when the dynamic image of the left-side projection sequence of the depth video V of the behavior sample is inputted into the left-side projection feature extraction module: and Q^{t} represents a feature that is extracted when the dynamic image of the top-side projection sequence of the depth video V of the behavior sample is inputted into the top-side projection feature extraction module.

Preferably, a linkage feature is extracted in step 4) by combining every two, every three and every four of the features extracted by all the feature extraction modules in step 3) to obtain multiple projection combinations.

The linkage feature of each projection combination is calculated as follows:
connecting the features in the projection combination by channel to obtain a combined feature Q∈H×W×γJ, in which H and W represent a height and a width of each feature in the projection combination respectively, J represents the quantity of channels of each feature in the projection combination, and γ represents the quantity of features in the projection combination: calculating an explicit linkage feature Z_{α} of each projection combination and an implicit linkage feature Z_{β} of each projection combination; and calculating a linkage feature Z of the projection combination according to a formula:

$$Z = {Z}_{α} ⊕ {Z}_{β} ,$$

in which ⊕ represents addition of elements in corresponding locations of matrices Z_{α} and Z_{β}.

Preferably, in step 5), the linkage features of all the projection combinations are connected by channel, and inputted into the average pooling layer. An output Γ of the average pooling layer is inputted into a fully connected layer 2. The quantity of neurons in the fully connected layer 2 is D₂. An output S₂ of the fully connected layer 2 is calculated as follows:

$${S}_{2} = {ϕ}_{relu} ( {W}_{2} \cdot Γ + {θ}_{2} ) ,$$

in which ϕᵣₑₗᵤ is an activation function relu, W₂ is a weight of the fully connected layer 2, and θ₂ is a bias vector of the fully connected layer 2.

The output S₂ of the fully connected layer 2 is inputted into a fully connected layer 3 with an activation function softmax. The quantity of neurons in the fully connected layer 3 is K. An output S₃ is calculated as follows:

$${S}_{3} = {ϕ}_{soft max} ( {W}_{3} \cdot {S}_{2} + {θ}_{3} ) ,$$

in which ϕ_{soft max} represents the activation function softmax, W₃ is a weight of the fully Ø connected layer 3, and θ₃ is a bias vector of the fully connected layer 3.

Preferably, an input of the depth video linkage feature-based behavior recognition network in step 6) is the depth video of the behavior sample, and an output thereof is a probability that a corresponding behavior sample belongs to a respective behavior category, i.e., an output of the fully connected layer 3 is Q₃. A loss function L of the network is:

$$L = - {\sum }_{g = 1}^{G} {\sum }_{p = 1}^{K} {[ {1}_{g} ]}_{p} log ( {[ {Q}_{3}^{q} ]}_{p} ) ,$$

in which G is a total quantity of training behavior samples, K is the quantity of categories of the behavior samples, Q₃^{g} is a network output of a g^{th} behavior sample, and l_{g} is an expected output of the g^{th} behavior sample. p^{th}-dimension data of l_{g} is defined as:

$$[ {1}_{g} ] = \{ \begin{matrix}1 , if p = {l}_{e} \\ 0 , else\end{matrix} ,$$

in which l₈ is a tag value of the g^{th} behavior sample.

Preferably, the behavior recognition in step 8) includes: inputting a depth video of each tested behavior sample into the trained depth video linkage feature-based behavior recognition network to obtain a predicted probability value of a current tested behavior video sample belonging to each behavior category, and taking the behavior category with the largest probability value as the finally predicted behavior category to which the current tested behavior video sample belongs, so as to implement the behavior recognition.

Preferably, the explicit linkage feature of each projection combination is calculated by the following steps:
1) calculating an average value of features of each channel and an average value Q̅ₐ of features of an a^{th} channel of the combined feature Q according to a formula:

$${\overline{Q}}_{a} = \frac{1}{H \times W} {\sum }_{h , w}^{H , W} {Q}_{a , h , w} ,$$

in which Q_{a,h,w} represents an h^{th}-row and w^{th}-column element value of the a^{th} channel of the combined feature Q;
2) calculating a degree of explicit correlation P∈γJ×γJ of features between different channels of the combined feature Q, a degree of explicit correlation P^{a,b} of features between the a^{th} channel and a b^{th} channel being calculated according to a formula:

$${P}_{a , b} = \frac{1}{H \times W} {\sum }_{h , w}^{H , W} ( {Q}_{a , h , w} - {\overline{Q}}_{a} ) ( {Q}_{b , h , w} - {\overline{Q}}_{b} ) ,$$

in which Q_{b,h,w} represents an h^{th}-row and w^{th}-column element value of the b^{th} channel of the combined feature Q, and Q̅_{b} represents an average value of features of the b^{th} channel of the combined feature Q;
3) calculating a degree of normalized explicit correlation \hat{P}∈γJ×γJ of features between the different channels of the combined feature Q, a degree of normalized explicit correlation \hat{P}^{a,b} of features between the a^{th} channel and the b^{th} channel being calculated according to a formula:

$${\hat{P}}_{a , b} = \frac{{e}^{{P}^{a , b}}}{{\sum }_{b = 1}^{γ J} {e}^{{P}^{a , b}}} ;$$

and
4) calculating an explicit linkage feature Zₐ∈H×W×γJ of the projection combination, a feature Z_{α}^{a} of the a^{th} channel of Q_{α} being calculated according to a formula:

$${Z}_{α}^{a} = {\sum }_{b = 1}^{γ J} {\hat{P}}^{a , b} {Q}_{b} ,$$

in which Q_{b} represents a feature of the b^{th} channel of the combined feature Q.

Preferably, the implicit linkage feature of each projection combination is calculated by the following steps:
1) calculating an average value of each channel of the combined feature Q, and connecting the average values of all the channels into a vector Q̅=(Q̅₁, Q̅₂, . . . , Q̅_{γJ});
2) inputting the vector Q̅ into the fully connected layer 1, the quantity of neurons of the fully connected layer 1 being γJ, an output of the fully connected layer 1 being S₁=ϕ_{sigmoid}(W₁·Q̅+θ₁)∈ [symbol] , in which ϕ_{sigmoid} represents an activation function sigmoid, Wₜ∈γJ×γJ represents a weight of the fully connected layer 1, and θ₁∈ [symbol] represents a bias vector of the fully connected layer 1; and
3) calculating an implicit linkage feature Z_{β}∈H×W×γJ of the projection combination, a feature Z_{β}^{a} of an a^{th} channel of Z_{β} being calculated according to a formula:

$${Z}_{β}^{a} = {S}_{1}^{a} \cdot {Q}_{a} ,$$

in which S₁^{a} represents a value of an a^{th} element of the output S₁ of the fully connected layer 1.

The present invention has the following beneficial effects: 1) the depth video-based behavior recognition cannot acquire information such as human appearance, thereby protecting human privacy; meanwhile, the depth video is less susceptible to light, and thus can provide more abundant three-dimensional information about a behavior; and
2) information of the behavior in different dimensions can be acquired by projecting the depth video onto different planes, and these pieces of information can be combined to make it easier to recognize a human behavior; and the learned linkage features of the depth video in different dimensions are more discriminative for behavior recognition.

### BRIEF DESCRIPTION OF THE DRAWINGS

FIG. 1 is a flow chart according to the present invention;

FIG. 2 is a flow chart of a feature extraction module;

FIG. 3 is a flow chart illustrating extraction of linkage features from each projection combination;

FIG. 4 is a flow chart of a depth video linkage feature-based behavior recognition network;

FIGS. 5A-5D are schematic diagrams of planar projections of a hand waving behavior according to an embodiment; and

FIG. 6 is a dynamic image of a front-side projection of a hand waving behavior according to an embodiment.

### DETAILED DESCRIPTION

The technical solutions in the embodiments of the present invention will be described clearly and completely with reference to the accompanying drawings in the embodiments of the present invention. Obviously, the described embodiments are only part of embodiments of the present invention, rather than all of the embodiments. According to the described embodiments of the present invention, all other embodiments obtained by those of ordinary skill in the art without any creative work fall within the protection scope of the present invention.

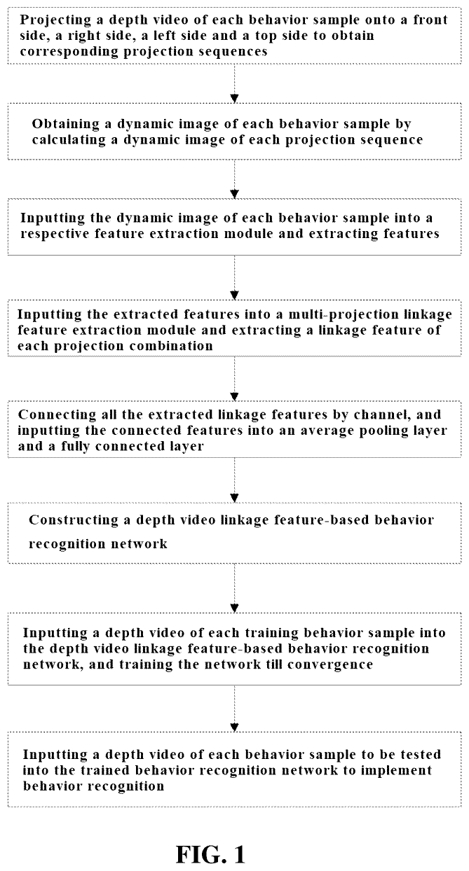

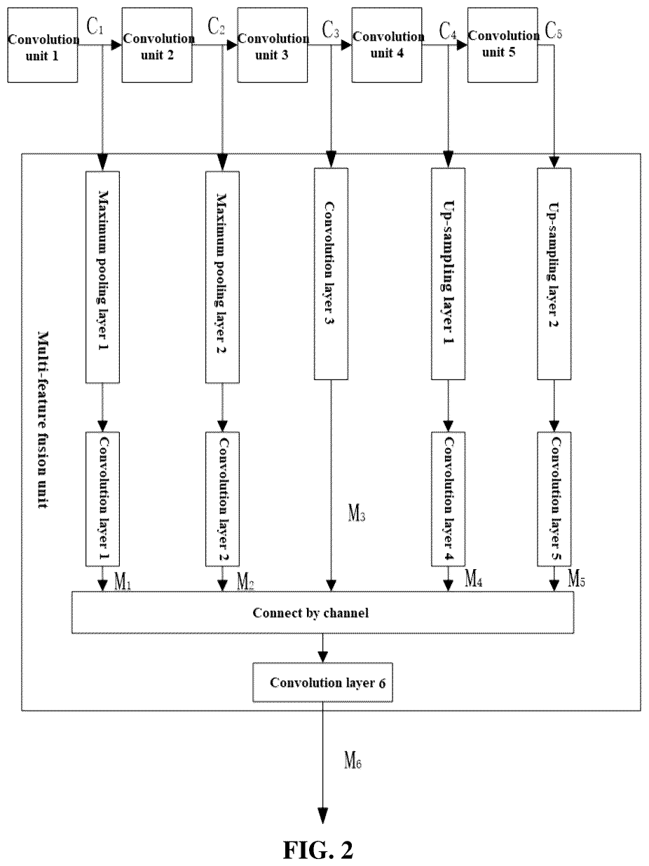

According to the embodiments of the present invention, referring to FIGS. 1-6, a depth video linkage feature-based behavior recognition method includes the following steps:
1) projecting a depth video of each behavior sample onto a front side, a right side, a left side and a top side to obtain four projection sequences;
2) obtaining four dynamic images of each behavior sample by calculating dynamic images of the four projection sequences of each behavior sample;
3) inputting the four dynamic images into respective feature extraction modules and extracting features;
4) inputting the features extracted from the dynamic images of the four projection sequences into a multi-projection linkage feature extraction module and extracting a linkage feature of each projection combination;
5) connecting the extracted linkage features of all the projection combinations by channel, and inputting the connected features into an average pooling layer and two fully connected layers;
6) constructing a depth video linkage feature-based behavior recognition network;
7) inputting a depth video of each training behavior sample into the depth video linkage feature-based behavior recognition network, and training the network till convergence; and
8) inputting a depth video of each tested behavior sample into the trained depth video linkage feature-based behavior recognition network to implement behavior recognition.

The dynamic image is obtained in step 2) as follows.

By taking a front-side projection sequence V_{front}={Fₜ|t∈[1, N]} of a depth video V of the behavior sample as an example, the dynamic image is calculated as follows:
vectorizing Fₜ first, i.e., connecting a row vector of Fₜ into a new row vector iₜ;
solving an arithmetic square root of each element in the row vector iₜ to obtain a new vector wₜ, i.e.:

$${w}_{t} = \sqrt{{i}_{t}} ,$$

in which \sqrt{iₜ} indicates to solve an arithmetic square root of each element in the row vector iₜ, wₜ being denoted by a frame vector of a t^{th}-frame image of the front-side projection sequence V_{front} of the depth video V of the behavior sample;
calculating a feature vector vₜ of the t^{th}-frame image of the front-side projection sequence V_{front} of the depth video V of the behavior sample according to a formula:

$${v}_{t} = \frac{1}{t} {\sum }_{κ = 1}^{t} {w}_{κ} ,$$

in which Σ_{κ=1}^{t} w_{κ} represents summation of frame vectors from a first-frame image to the t^{th}-frame image of the front-side projection sequence V_{front} of the depth video V of the behavior sample;
calculating a score Bₜ of the t^{th}-frame image Fₜ of the front-side projection sequence V_{front} of the depth video V of the behavior sample according to a formula:

$${B}_{t} = {u}^{T} \cdot {v}_{t} ,$$

in which u is a vector in a dimension A, A=R×C, u^{T} represents transposition of the vector u, and u^{T}·vₜ indicates to calculate a dot product of the feature vector vₜ and a vector obtained by transposing the vector u;
calculating a value of u, such that frame images in the front-side projection sequence V_{front} have higher and higher scores from front to back, i.e., the larger the t is, the higher the score Bₜ is, u being calculated by using RankSVM as follows:

$$u = {arg min}_{u} E ( u ) , \\ E ( u ) = \frac{λ}{2} {‖ u ‖}^{2} + \frac{2}{T ( T - 1 )} \times {\sum }_{c > j} max \{ 0 , 1 - {B}_{c} + {B}_{j} \} ,$$

in which

$${arg min}_{u} E ( u )$$

represents u that minimizes the value of E(u), λ is a constant, and ∥u∥² indicates to calculate a sum of squares of all elements in the vector u; B_{c} and Bⱼ respectively represent a score of a c^{th}-frame image and a score of a j^{th}-frame image of the front-side projection sequence V_{front} of the depth video V of the behavior sample, and max{0,1−B_{c}+Bⱼ} indicates to choose a larger value of 0 and 1−B_{c}+Bⱼ; and
in response to calculating the vector u by using RankSVM, arranging the vector u in an image form with the same size as Fₜ to obtain u′∈R×C, u′ being the dynamic image of the front-side projection sequence V_{front} of the depth video V of the behavior sample.

The dynamic images of a right-side projection sequence, a left-side projection sequence and a top-side projection sequence of the depth video V of the behavior sample are calculated in the same way as the dynamic image of the front-side projection sequence.

A linkage feature of each projection combination is extracted in step 4) as follows.

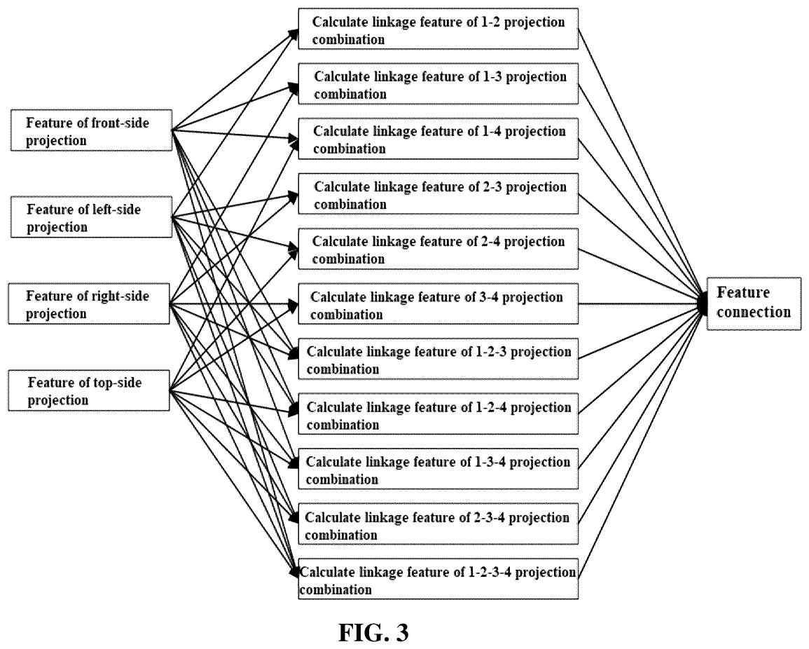

As shown in FIG. 3, every two, every three and every four of the features extracted after the dynamic images of the four projection sequences are inputted into the respective feature extraction modules are combined to obtain a total of 11 projection combinations. A combination of the features extracted from the dynamic images of the front-side projection sequence and of the left-side projection sequence is denoted by a 1-2 projection combination. A combination of the features extracted from the dynamic images of the front-side projection sequence and of the right-side projection sequence is denoted by a 1-3 projection combination. A combination of the features extracted from the dynamic images of the front-side projection sequence and of the top-side projection sequence is denoted by a 1-4 projection combination. A combination of the features extracted from the dynamic images of the left-side projection sequence and of the right-side projection sequence is denoted by a 2-3 projection combination. A combination of the features extracted from the dynamic images of the left-side projection sequence and of the top-side projection sequence is denoted by a 2-4 projection combination. A combination of the features extracted from the dynamic images of the right-side projection sequence and of the top-side projection sequence is denoted by a 3-4 projection combination. A combination of the features extracted from the dynamic images of the front-side projection sequence, of the left-side projection sequence and of the right-side projection sequence is denoted by a 1-2-3 projection combination. A combination of the features extracted from the dynamic images of the front-side projection sequence, of the left-side projection sequence and of the top-side projection sequence is denoted by a 1-2-4 projection combination. A combination of the features extracted from the dynamic images of the front-side projection sequence, of the right-side projection sequence and of the top-side projection sequence is denoted by a 1-3-4 projection combination. A combination of the features extracted from the dynamic images of the left-side projection sequence, of the right-side projection sequence and of the top-side projection sequence is denoted by a 2-3-4 projection combination. A combination of the features extracted from the dynamic images of the front-side projection sequence, of the left-side projection sequence, of the right-side projection sequence and of the top-side projection sequence is denoted by a 1-2-3-4 projection combination.

The linkage feature of each projection combination is calculated as follows:
connecting the features in the projection combination by channel to obtain a combined feature Q∈H×W×γJ, in which H and W represent a height and a width of each feature in the projection combination respectively, J represents the quantity of channels of each feature in the projection combination, and γ represents the quantity of features in the projection combination.

An explicit linkage feature of each projection combination is calculated first by the following steps:
1) calculating an average value of features of each channel and an average value Q̅ₐ of features of an a^{th} channel of the combined feature Q according to a formula:

$${\overline{Q}}_{a} = \frac{1}{H \times W} {\sum }_{h , w}^{H , W} {Q}_{a , h , w} ,$$

in which Q_{a,h,w} represents an h^{th}-row and w^{th}-column element value of the a^{th} channel of the combined feature Q;
2) calculating a degree of explicit correlation P∈γJ×γJ of features between different channels of the combined feature Q, a degree of explicit correlation P^{a,b} of features between the a^{th} channel and a b^{th} channel being calculated according to a formula:

$${P}^{a , b} = \frac{1}{H \times W} {\sum }_{h , w}^{H , W} ( {Q}_{a , h , w} - {\overline{Q}}_{a} ) ( {Q}_{b , h , w} - {\overline{Q}}_{b} ) ,$$

in which Q_{b,h,w} represents an h^{th}-row and w^{th}-column element value of the b^{th} channel of the combined feature Q, and Q̅_{b} represents an average value of features of the b^{th} channel of the combined feature Q;
3) calculating a degree of normalized explicit correlation P∈γJ×γJ of features between the different channels of the combined feature Q, a degree of normalized explicit correlation \hat{P}_{a,b} of features between the a^{th} channel and the b^{th} channel being calculated according to a formula:

$${\hat{P}}^{a , b} = \frac{{e}^{{P}^{a , b}}}{{\sum }_{b = 1}^{γ J} {e}^{{P}^{a , b}}} ;$$

and
4) calculating an explicit linkage feature Z_{α}∈H×W×γJ of the projection combination, a feature Z_{α}^{a} of the a^{th} channel of Z_{α} being calculated according to a formula:

$${Z}_{α}^{a} = {\sum }_{b = 1}^{γ J} {\hat{P}}^{a , b} {Q}_{b} ,$$

in which Q_{b} represents a feature of the b^{th} channel of the combined feature Q.

After that, an implicit linkage feature of each projection combination is calculated by the following steps:
1) calculating an average value of each channel of the combined feature Q, and connecting the average values of all the channels into a vector Q̅=(Q̅₁, Q̅₂, . . . , Q̅_{γJ});
2) inputting the vector into a fully connected layer 1, the quantity of neurons of the fully connected layer 1 being γJ, an output of the fully connected layer 1 being, S₁=ϕ_{sigmoid}(W₁·Q̅+θ₁)∈ [symbol] , in which ϕ_{sigmoid} represents an activation function sigmoid, Wₗ∈γJ×γJ represents a weight of the fully connected layer 1, and θ₁∈ [symbol] represents a bias vector of the fully connected layer 1; and
3) calculating an implicit linkage feature Z_{β}∈H×W×γJ of the projection combination, a feature Z_{β}^{a} of an a^{th} channel of Z_{β} being calculated according to a formula:

$${Z}_{β}^{a} = {S}_{1}^{a} \cdot {Q}_{a} ,$$

in which S₁^{a} represents a value of an a^{th} element of the output S₁ of the fully connected layer 1.

Finally, the linkage feature Z of each projection combination is calculated according to a formula:

$$Z = {Z}_{α} ⊕ {Z}_{β} ,$$

in which ⊕ represents addition of elements in corresponding locations of matrices Z_{α} and Z_{β}.

There are 11 projection combinations in total, and hence 11 linkage features may be obtained.

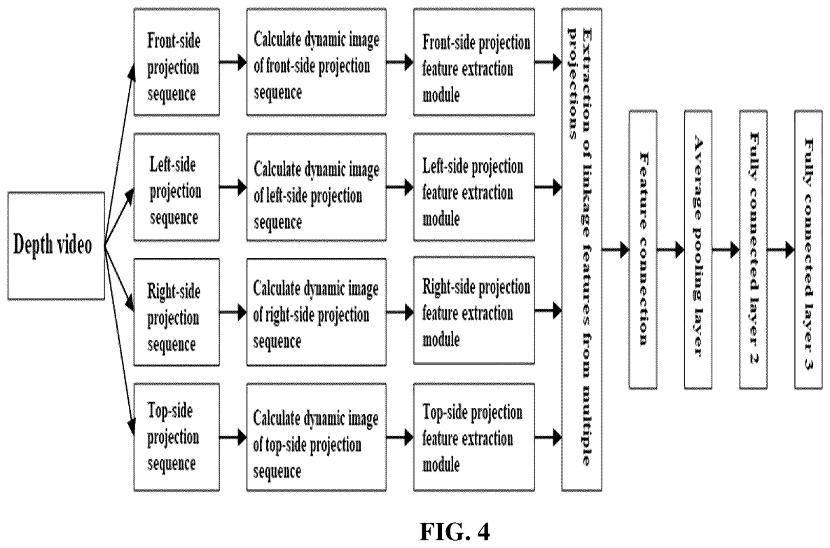

The depth video linkage feature-based behavior recognition network is constructed in step 6). As shown in FIG. 4, an input of the network is the depth video of the behavior sample, an output thereof is a probability that a corresponding behavior sample belongs to the respective behavior category, i.e., an output of a fully connected layer 3 is Q₃. A loss function L of the network is:

$$L = - {\sum }_{g = 1}^{G} {\sum }_{p = 1}^{K} {[ {l}_{g} ]}_{p} log ( {[ {Q}_{3}^{g} ]}_{p} ) ,$$

in which G is the total number of training behavior samples, K is the quantity of categories of the behavior samples, Q₃^{g} is a network output of a g^{th} behavior sample, l_{g} is an expected output of the g^{th} behavior sample, and p^{th}-dimension data of l_{g} is defined as:

$${[ {l}_{g} ]}_{p} = \{ \begin{matrix}1 , & if p = {l}_{g} \\ 0 , & else\end{matrix} ,$$

in which l_{g} is a tag value of the g^{th} behavior sample.

In step 7), the depth video of each training behavior sample is inputted into the depth video linkage feature-based behavior recognition network, and the network is trained till convergence.

In step 8), the depth video of each tested behavior sample is inputted into the trained depth video linkage feature-based behavior recognition network to obtain a predicted probability value of a current tested behavior video sample belonging to the respective behavior category, and the behavior category with the largest probability value is the finally predicted behavior category to which the current tested behavior video sample belongs, so as to implement the behavior recognition.

### Embodiments

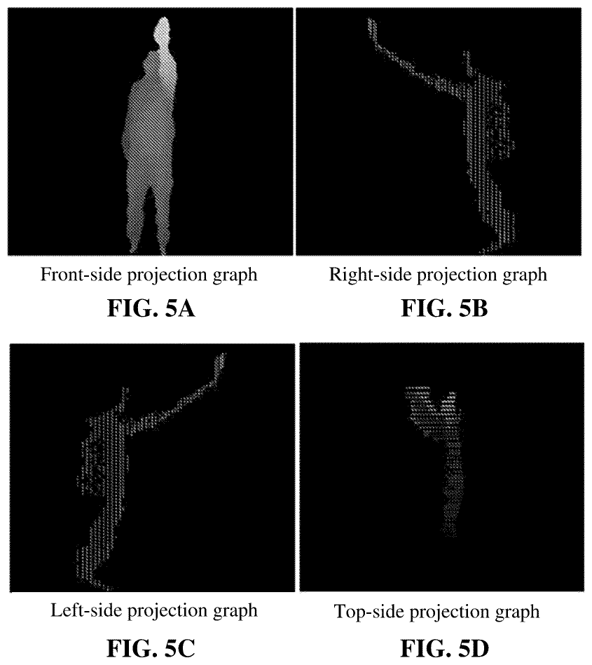

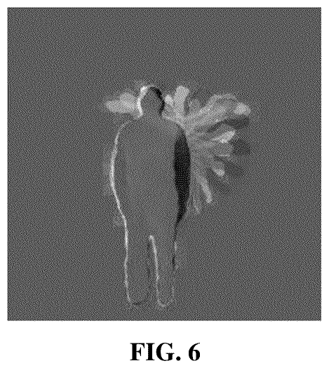

As shown in FIGS. 5A-5D and 6:
1) there are 2,400 samples in total in a behavior sample set, including 8 behavior categories, with 300 samples in each behavior category. Two thirds of the samples in each behavior category are randomly selected and assigned to a training set, and the remaining one third are assigned to a testing set, to obtain a total of 1,600 training samples and 800 testing samples. Each behavior sample consists of all frames in a depth video of the sample. A depth video V of any behavior sample is taken as an example:

$$V = \{ {I}_{t} \vert t ∈ [ 1 , 50 ] \} ,$$

in which t represents a time index. There are 50 frames in total in the behavior sample. Jᵢ∈240×240 is a matrix representation of a t^{th}-frame depth image of the depth video V of the behavior sample. The t^{th}-frame depth image has 240 rows and 240 columns. indicates that a matrix is a real matrix. Iₜ(xᵢ, yᵢ)=dᵢ represents a depth value of a point pᵢ with coordinates (xᵢ, yᵢ) on the t^{th}-frame depth image, i.e., a distance between the point pᵢ and a depth camera.

The depth video V of the behavior sample is respectively projected onto four planes, including a front side, a right side, a left side and a top side. At this time, the depth video V of the behavior sample may be denoted by a set of four projection sequences, which is expressed by the following formula:

$$V = \{ {V}_{front} , {V}_{right} , {V}_{left} , {V}_{top} \} ,$$

in which V_{front} represents a projection sequence obtained by projecting the depth video V of the behavior sample onto a front side, V_{right} represents a projection sequence obtained by projecting the depth video V of the behavior sample onto a right side, V_{left} represents a projection sequence obtained by projecting the depth video V of the behavior sample onto a left side, and the Vₜₒₚ represents a projection sequence obtained by projecting the depth video V of the behavior sample onto a top side.

V_{front}={Fₜ|t∈[1,50]}, in which Fₜ∈240×240 represents a projection graph obtained by projecting the t^{th}-frame depth image of the depth video V of the behavior sample onto the front side. An abscissa value xᵢ, an ordinate value yᵢ and a depth value dᵢ of the point pᵢ in the depth image respectively determine an abscissa value xᵢ^{ƒ}, an ordinate value yᵢ^{ƒ} and a pixel value zᵢ^{ƒ} of a point projected from the point pᵢ onto the projection graph Fₜ, which are denoted by the formulas:

$${F}_{t} ( {x}_{i}^{f} , {y}_{i}^{f} ) = {z}_{i}^{f} , \\ {x}_{i}^{f} = {x}_{i} , {y}_{i}^{f} = {y}_{i} , {z}_{i}^{f} = {f}_{1} ( {d}_{i} ) ,$$

in which ƒ₁ is a linear function indicating that the depth value dᵢ is mapped to an interval [0.255], such that the smaller the depth value is, the larger the pixel value on the projection graph is, i.e., the closer the point is to the depth camera, the brighter the point is on a front-side projection graph.

V_{right}={Rₜ|t∈[1,50]}, in which Rₜ∈240×240 represents a projection graph obtained by projecting the t^{th}-frame depth image onto the right side. There may be more than one point projected onto the same location on the projection graph when the depth image is projected onto the right side. A point closest to an observer, i.e., a point furthest from a projection plane, can be seen when a behavior is observed from the right side. Therefore, an abscissa value of the point furthest from the projection plane on the depth image should be reserved, and a pixel value of the point in this location of the projection graph is calculated according to the abscissa value. For this purpose, points in the depth image are traversed column by column from a column with the smallest abscissa x in the depth image in a direction in which x increases, and are projected onto the projection graph. An abscissa value xᵢ, an ordinate value yᵢ and a depth value dᵢ of the point pᵢ in the depth image respectively determine a pixel value zᵢ^{r}, an ordinate value yᵢ^{r} and an abscissa value xᵢ^{r} of a point in the projection graph Rₜ, which are denoted by the formulas:

$${R}_{t} ( {x}_{i}^{r} , {y}_{i}^{r} ) = {z}_{i}^{r} , \\ {x}_{i}^{r} = {d}_{i} , {y}_{i}^{r} = {y}_{i} , {z}_{i}^{r} = {f}_{2} ( {x}_{i} ) ,$$

in which ƒ₂ is a linear function indicating that the abscissa value xᵢ is mapped to an interval [0,255] In a case that x continues to increase, there may be a new point that should be reserved, and the new point and the previously projected point are projected onto the same location in the projection graph, i.e., a pixel value of this location in the projection graph is calculated by using the abscissa value of the point with the largest abscissa value, i.e., zᵢ^{r}=ƒ₂(xₘ), in which xₘ=max xᵢ, xᵢ∈X_{R}, X_{R} is a set of abscissas of all points with ordinate values yᵢ^{r} and depth values xᵢ^{r} in the depth image, and max xᵢ, xᵢ∈X_{R} represents a maximum abscissa value in the set X_{R}.

V_{left}={Lₜ|t∈[1,50]}, in which Lₜ∈240×240 represents a projection graph obtained by projecting the t^{th}-frame depth image onto the left side. Similar to acquisition of the right-side projection graph, in a case that multiple points are projected onto the same location on a left-side projection graph, a point furthest from a projection plane should be reserved. For this purpose, points in the depth image are traversed column by column from a column with the largest abscissa x in the depth image in a direction in which x decreases, and are projected onto the left-side projection graph. An abscissa value xᵢ, an ordinate value yᵢ and a depth value dᵢ of the point pᵢ in the depth image respectively determine a pixel value zᵢ^{t}, an ordinate value yᵢ^{t} and an abscissa value xᵢ^{t} of a point in the projection graph Lₜ. For a point projected onto the same coordinates (xᵢ^{l}, yᵢ^{l}) on the left-side projection graph, an abscissa value of the point with the smallest abscissa is selected to calculate a pixel value at the coordinates of the projection graph, which is denoted by a formula:

$${L}_{t} ( {x}_{i}^{l} , {y}_{i}^{l} ) = {z}_{i}^{l} , \\ {x}_{i}^{l} = {d}_{i} , {y}_{i}^{l} = {y}_{i} , {z}_{i}^{l} = {f}_{3} ( {x}_{n} ) ,$$

in which ƒ₃ is a linear function indicating that an abscissa value xₙ is mapped to an interval [0,255], xₙ=min xᵢ, xᵢ∈X_{L}, in which X_{L} is a set of abscissas of all points with ordinate values yᵢ^{l} and depth values xᵢ^{l} in the depth image, and min xᵢ,xᵢ∈X₁ represents a minimum abscissa value in the set X_{L}.

Vₜₒₚ={Tₜ|t∈[1,50]}, in which Oₜ∈240×240 represents a projection graph obtained by projecting the t^{th}-frame depth image onto the top side. In a case that multiple points are projected onto the same location on a top-side projection graph, a point furthest from a projection plane is reserved. Points in the depth image are traversed column by column from a column with the smallest ordinate y on the depth image in a direction in which y increases, and are projected onto the top-side projection graph. An abscissa value xᵢ, an ordinate value yᵢ and a depth value dᵢ of the point pᵢ in the depth image respectively determine an abscissa value xᵢ^{o}, a pixel value zᵢ^{o} and an ordinate value yᵢ^{o} of a point of the point pᵢ projected onto a projection graph Oₜ. For a point projected onto the same coordinates (xᵢ^{o}, yᵢ^{o}) on the projection graph, an ordinate value of the point with the largest ordinate is selected to calculate a pixel value at the coordinates of the projection graph, which is denoted by a formula:

$${O}_{t} ( {x}_{i}^{o} , {y}_{i}^{o} ) = {z}_{i}^{o} , \\ {x}_{i}^{o} = {x}_{i} , {y}_{i}^{o} = {d}_{i} , {z}_{i}^{o} = {f}_{4} ( {y}_{q} ) ,$$

in which ƒ₄ is a linear function indicating that an ordinate value y_{q} is mapped to an interval [0,255]; y_{q}=max yᵢ, yᵢ∈Yₒ, in which Yₒ is a set of ordinates of all points with abscissa values xᵢ^{o} and depth values yᵢ^{o} in the depth image, and max yᵢ, yᵢ∈Yₒ represents a maximum ordinate value in the set Yₒ.
2) dynamic images of four projection sequences of the depth video of each behavior sample are calculated to obtain four dynamic images of each behavior sample. By taking the front-side projection sequence front V_{front}={Fₜ|t∈[1,50]} of the depth video V of the behavior sample as an example, the dynamic image is calculated as follows.
Fₜ is vectorized first, i.e., a row vector of Fₜ is connected into a new row vector iₜ.

An arithmetic square root of each element in the row vector iₜ is solved to obtain a new vector Wₜ, i.e.:

$${w}_{t} = \sqrt{{i}_{t}} ,$$

in which \sqrt{iₜ} indicates to solve an arithmetic square root of each element in the row vector iₜ. Wₜ is denoted by a vector frame of a t^{th}-frame image of the front-side projection sequence V_{front} of the depth video V of the behavior sample.

A feature vector Vₜ of the t^{th}-frame image of the front-side projection sequence V_{front} of the depth video V of the behavior sample is calculated according to a formula:

$${v}_{t} = \frac{1}{t} {\sum }_{κ = 1}^{t} {w}_{κ} ,$$

in which Σ_{κ=1}^{t} W_{κ} represents summation of frame vectors from a first-frame image to the t^{th}-frame image of the front-side projection sequence V_{front} of the depth video V of the behavior sample.

A score Bₜ of the t^{th}-frame image Fₜ of the front-side projection sequence V_{front} of the depth video V of the behavior sample is calculated according to a formula:

$${B}_{t} = {u}^{T} \cdot {v}_{t} ,$$

in which u is a vector in a dimension of 57600, u^{T} represents transposition of the vector u, and u^{T}·vₜ indicates to calculate a dot product of the feature vector Vₜ and a vector obtained by transposing the vector u.

A value of u is calculated, such that frame images in the front-side projection sequence V_{front} have higher and higher scores from front to back, i.e., the larger the t is, the higher the score Bₜ is. u is calculated by using RankSVM as follows:

$$u = {arg min}_{u} E ( u ) \\ E ( u ) = \frac{λ}{2} {‖ u ‖}^{2} + \frac{1}{1225} \times {\sum }_{c > j} max \{ 0 , 1 - {B}_{c} + {B}_{j} \} ,$$

in which

$${arg min}_{u} E ( u )$$

represents u that minimizes the value of E(u), λ is a constant, and ∥u∥² indicates to calculate a sum of squares of each element in the vector u; B_{c} and Bⱼ respectively represent a score of a c^{th}-frame image and a score of a j^{th}-frame image of the front-side projection sequence V_{front} of the depth video V of the behavior sample, and max{0,1−B_{c}+Bⱼ} indicates to choose a larger value of 0 and 1−B_{c}+Bⱼ.

In response to calculating the vector u by using RankSVM, the vector u is arranged in an image form with the same size as Fₜ to obtain u′∈240×240. u′ is a dynamic image of the front-side projection sequence V_{front} of the depth video V of the behavior sample. FIGS. 5A-5D show dynamic images of a front-side projection of a hand waving behavior.

The dynamic images of the right-side projection sequence, the left-side projection sequence and the top-side projection sequence of the depth video V of the behavior sample are calculated in the same way as the dynamic images of the front-side projection sequence.

3) The dynamic images of the front-side projection sequence, the right-side projection sequence, the left-side projection sequence and the top-side projection sequence of the depth video of the behavior sample are inputted into their respective feature extraction modules for extracting features. The feature extraction module includes a convolution unit 1, a convolution unit 2, a convolution unit 3, a convolution unit 4, a convolution unit 5 and a multi-feature fusion unit.

The convolution unit 1 includes two convolution layers and one maximum pooling layer. Each convolution layer has 64 convolution kernels, and each convolution kernel has a size of 3×3. A pooling kernel of the maximum pooling layer has a size of 2×2. An output of the convolution unit 1 is C₁.

The convolution unit 2 includes two convolution layers and one maximum pooling layer. Each convolution layer has 128 convolution kernels, and each convolution kernel has a size of 3×3. A pooling kernel of the maximum pooling layer has a size of 2×2. An input of the convolution unit 2 is C₁ and an output thereof is C₂.

The convolution unit 3 includes three convolution layers and one maximum pooling layer. Each convolution layer has 256 convolution kernels, and each convolution kernel has a size of 3×3. A pooling kernel of the maximum pooling layer has a size of 2×2. An input of the convolution unit 3 is C₂ and an output thereof is C₃.

The convolution unit 4 includes three convolution layers and one maximum pooling layer. Each convolution layer has 512 convolution kernels, and each convolution kernel has a size of 3×3. A pooling kernel of the maximum pooling layer has a size of 2×2. An input of the convolution unit 4 is C₃ and an output thereof is C₄.

The convolution unit 5 includes three convolution layers and one maximum pooling layer. Each convolution layer has 512 convolution kernels, and each convolution kernel has a size of 3×3. A pooling kernel of the maximum pooling layer has a size of 2×2. An input of the convolution unit 5 is C₄ and an output thereof is C₅.

Inputs of the multi-feature fusion unit are the output C₁ of the convolution unit 1, the output C₂ of the convolution unit 2, the output C₃ of the convolution unit 3, the output C₄ of the convolution unit 4 and the output C₅ of the convolution unit 5. The output C₁ of the convolution unit 1 is inputted into a maximum pooling layer 1 and a convolution layer 1 in the multi-feature fusion unit. A pooling kernel of the maximum pooling layer 1 has a size of 4×4. The convolution layer 1 has 512 convolution kernels, each convolution kernel has a size of 1×1, and an output of the convolution layer 1 is M₁.

The output C₂ of the convolution unit 2 is inputted into a maximum pooling layer 2 and a convolution layer 2 in the multi-feature fusion unit. A pooling kernel of the maximum pooling layer 2 has a size of 2×2. The convolution layer 2 has 512 convolution kernels, each convolution kernel has a size of 1×1, and an output of the convolution layer 2 is M₂.

The output C₃ of the convolution unit 3 is inputted into a convolution layer 3 in the multi-feature fusion unit. The convolution layer 3 has 512 convolution kernels, each convolution kernel has a size of 1×1, and an output of the convolution layer 3 is M₃.

The output C₄ of the convolution unit 4 is inputted into an up-sampling layer 1 and a convolution layer 4 in the multi-feature fusion unit. The convolution layer 4 has 512 convolution kernels, each convolution kernel has a size of 1×1, and an output of the convolution layer 4 is M₄.

The output C₅ of the convolution unit 5 is inputted into an up-sampling layer 2 and a convolution layer 5 in the multi-feature fusion unit. The convolution layer 5 has 512 convolution kernels, each convolution kernel has a size of 1×1, and an output of the convolution layer 5 is M₅. The output M₁ of the convolution layer 1, the output M₂ of the convolution layer 2, the output M₃ of the convolution layer 3, the output M₄ of the convolution layer 4 and the output M₅ of the convolution layer 5 are connected by channel and inputted into a convolution layer 6. The convolution layer 6 has 256 convolution kernels, each convolution kernel has a size of 1×1, and an output of the convolution layer 6 is M₆. An output of the multi-feature fusion unit is the output M₆ of the convolution layer 6.

Dynamic images of the front-side projection sequence, the right-side projection sequence, the left-side projection sequence and the top-side projection sequence of the depth video V of the behavior sample are respectively inputted into their respective feature extraction modules, namely, a front-side projection feature extraction module, a right-side projection feature extraction module, a left-side projection feature extraction module and a top-side projection feature extraction module. The four feature extraction modules are of the same structure. However, during network training, the four modules do not share parameters. The four feature extraction modules respectively output features Q^{ƒ}, Q^{r}, Q^{l} and Q^{t}, which respectively represent a feature that is extracted when the dynamic image of the front-side projection sequence of the depth video V of the behavior sample is inputted into the front-side projection feature extraction module, a feature that is extracted when the dynamic image of the right-side projection sequence of the depth video V of the behavior sample is inputted into the right-side projection feature extraction module, a feature that is extracted when the dynamic image of the left-side projection sequence of the depth video V of the behavior sample is inputted into the left-side projection feature extraction module, and a feature that is extracted when the dynamic image of the top-side projection sequence of the depth video V of the behavior sample is inputted into the top-side projection feature extraction module.

4) The features extracted by all the feature extraction modules are inputted into the multi-projection linkage feature extraction module, and a linkage feature of each projection combination is extracted. Every two, every three and every four of the features extracted in response to the dynamic images of the four projection sequences being inputted into the respective feature extraction modules are combined to obtain a total of 11 projection combinations. A combination of the features extracted from the dynamic images of the front-side projection sequence and of the left-side projection sequence is denoted by a 1-2 projection combination. A combination of the features extracted from the dynamic images of the front-side projection sequence and of the right-side projection sequence is denoted by a 1-3 projection combination. A combination of the features extracted from the dynamic images of the front-side projection sequence and of the top-side projection sequence is denoted by a 1-4 projection combination. A combination of the features extracted from the dynamic images of the left-side projection sequence and of the right-side projection sequence is denoted by a 2-3 projection combination. A combination of the features extracted from the dynamic images of the left-side projection sequence and of the top-side projection sequence is denoted by a 2-4 projection combination. A combination of the features extracted from the dynamic images of the right-side projection sequence and of the top-side projection sequence is denoted by a 3-4 projection combination. A combination of the features extracted from the dynamic images of the front-side projection sequence, of the left-side projection sequence and of the right-side projection sequence is denoted by a 1-2-3 projection combination. A combination of the features extracted from the dynamic images of the front-side projection sequence, of the left-side projection sequence and of the top-side projection sequence is denoted by a 1-2-4 projection combination. A combination of the features extracted from the dynamic images of the front-side projection sequence, of the right-side projection sequence and of the top-side projection sequence is denoted by a 1-3-4 projection combination. A combination of the features extracted from the dynamic images of the left-side projection sequence, of the right-side projection sequence and of the top-side projection sequence is denoted by a 2-3-4 projection combination. A combination of the features extracted from the dynamic images of the front-side projection sequence, of the left-side projection sequence, of the right-side projection sequence and of the top-side projection sequence is denoted by a 1-2-3-4 projection combination.

The linkage feature of each projection combination is calculated. By taking the 1-2 projection combination as an example, its linkage feature is calculated as follows:

The features and Q^{ƒ} in the 1-2 projection combination are connected by channel to obtain a combined feature Q∈H×W×512, in which H and W represent a height and a width of Q^{ƒ} and Q^{l}.

An explicit linkage feature of the projection combination is first calculated by the following steps:
(1) calculating an average value of features of each channel and an average value Q̅ₐ of features of an a^{th} channel of the combined feature Q according to a formula:

$${\overline{Q}}_{a} = \frac{1}{H \times W} {\sum }_{h , w}^{H , W} {Q}_{a , h , w} ,$$

in which Q_{a,h,w} represents an h^{th}-row and w^{th}-column element value of the a^{th} channel of the combined feature Q;
(2) calculating a degree of explicit correlation P∈512×512 of features between different channels of the combined feature Q, a degree of explicit correlation P^{a,b} of features between the a^{th} channel and a b^{th} channel being calculated according to a formula:

$${P}^{a , b} = \frac{1}{H \times W} {\sum }_{h , w}^{H , W} ( {Q}_{a , h , w} - {\overline{Q}}_{a} ) ( {Q}_{b , h , w} - {\overline{Q}}_{b} ) ,$$

in which Q_{b,h,w} represents an h^{th}-row and w^{th}-column element value of the b^{th} channel of the combined feature Q, and Q̅_{b} represents an average value of features of the b^{th} channel of the combined feature Q;
3) calculating a degree of normalized explicit correlation \hat{P}∈512×512 of features between the different channels of the combined feature Q, a degree of normalized explicit correlation \hat{P}^{a,b} of features between the a^{th} channel and the b^{th} channel being calculated according to a formula:

$${\hat{P}}^{a , b} = \frac{{e}^{{P}^{a , b}}}{{\sum }_{b = 1}^{512} {e}^{{P}^{a , b}}} ;$$

and
4) calculating an explicit linkage feature Z_{α}∈H×W×512 of the projection combination, a feature Z_{α}^{a} of the a^{th} channel of Z_{α} being calculated according to a formula:

$${Z}_{α}^{a} = {\sum }_{b = 1}^{512} {\hat{P}}^{a , b} {Q}_{b} ,$$

in which Q_{b} represents a feature of the b^{th} channel of the combined feature Q.

After that, an implicit linkage feature of each projection combination is calculated by the following steps:
(1) calculating an average value of each channel of the combined feature Q, and connecting the average values of all the channels into a vector Q̅=(Q̅₃, Q̅₂, . . . . , Q̅₅₁₂);
(2) inputting the vector Q̅ into the fully connected layer 1, the fully connected layer 1 having 512 neurons, an output of the fully connected layer 1 being, S₁=ϕ_{sigmoid}(W₁·Q̅+θ₁∈512×1, in which ϕ_{sigmoid} represents an activation function sigmoid, W₁∈512×512 represents a weight of the fully connected layer 1, θ₁∈512×1 and represents a bias vector of the fully connected layer 1; and
(3) calculating an implicit linkage feature Z_{β}∈H×W×512 of the projection combination, a feature Z_{β}^{a} of an a^{th} channel of Z_{β} being calculated according to a formula:

$${Z}_{β}^{a} = {S}_{1}^{a} \cdot {Q}_{a} ,$$

in which S₁^{a} represents a value of an a^{th} element of the output S₁ of the fully connected layer 1.

Finally, a linkage feature Z of the 1-2 projection combination is calculated according to a formula:

$$Z = {Z}_{a} ⊕ {Z}_{β} ,$$

in which ⊕ represents addition of elements in corresponding locations of matrices Z_{α} and Z_{β}.

There are 11 projection combinations in total, and hence 11 linkage features may be obtained by the calculation method described above.

5) The linkage features of the 11 projection combinations obtained are connected by channel, and inputted into the average pooling layer. An output Γ of the average pooling layer is inputted into a fully connected layer 2. The fully connected layer 2 has 1,024 neurons. An output S₂ of the fully connected layer 2 is calculated as follows:

$${S}_{2} = {ϕ}_{relu} ( {W}_{2} \cdot Γ + {θ}_{2} ) ,$$

in which ϕᵣₑₗᵤ is an activation function relu, W₂ is a weight of the fully connected layer 2, and θ₂ is a bias vector of the fully connected layer 2.

An output S₂ of the fully connected layer 2 is inputted into a fully connected layer 3 with an activation function softmax. The fully connected layer 3 has 8 neurons. An output S₃ of the fully connected layer 3 is calculated as follows:

$${S}_{3} = {ϕ}_{soft max} ( {W}_{3} \cdot {S}_{2} + {θ}_{3} ) ,$$

in which ϕ_{softmax} represents the activation function softmax, W₃ is a weight of the fully connected layer 3, and θ₃ is a bias vector of the fully connected layer 3.

6) A depth video linkage feature-based behavior recognition network is constructed. An input of the network is the depth video of the behavior sample, and an output thereof is a probability that a corresponding behavior sample belongs to the respective behavior category, i.e., the output of the fully connected layer 3 is Q₃. A loss function L of the network is:

$$L = - {\sum }_{g = 1}^{2400} {\sum }_{𝓅 = 1}^{8} {[ {l}_{g} ]}_{𝓅} log ( {[ {Q}_{3}^{g} ]}_{𝓅} ) ,$$

in which Q₃^{g} is a network output of a g^{th} behavior sample, l_{g}is an expected output of the g^{th} behavior sample, and p^{th}-dimension data of l_{g} is defined as:

$${[ {l}_{g} ]}_{𝓅} = \{ \begin{matrix}1 , if p = {l}_{g} \\ 0 , else\end{matrix} ,$$

in which l_{g} is a tag value of the g^{th} behavior sample.

7) A depth video of each training behavior sample is inputted into the depth video linkage feature-based behavior recognition network, and the network is trained till convergence.

8) A depth video of each tested behavior sample is inputted into the trained depth video linkage feature-based behavior recognition network to obtain a predicted probability value of a current tested behavior video sample belonging to the respective behavior category. The behavior category with the largest probability value is taken as the finally predicted behavior category to which the current tested behavior video sample belongs, so as to implement the behavior recognition.

The activation function relu has a formula f(x)=max(0, x). An input of the function is x, and an output thereof is the larger one of x and 0.

The activation function softmax has a formula

$${S}_{i} = \frac{{e}^{i}}{{\sum }_{j = 1}^{n} {e}^{j}} ,$$

in which i represents an output of an i^{th} neuron in the fully connected layer, J represents an output of a j^{th} neuron in the fully connected layer, n represents the quantity of neurons in the fully connected layer, and Sᵢ represents an output of the i^{th} neuron in the fully connected layer according to the activation function softmax.

The activation function sigmoid has a formula

$$f ( x ) = \frac{1}{1 + {e}^{- x}} .$$

An input of the function is x, and an output thereof is

$$\frac{1}{1 + {e}^{- x}} .$$

x represents the input of the activation function sigmoid and ƒ(x) represents the output of the activation function sigmoid.

It should be noted that, in this context, relational terms such as “first” and “second” are used merely to distinguish one entity or operation from another entity or operation, and do not necessarily require or imply any actual relationship or order between these entities or operations. The term “including”, “include” or any other variants thereof is intended to cover a non-exclusive inclusion, such that a process, method, article or device that includes a series of elements includes not only those elements but also other elements that are not specifically listed, or further includes elements that are inherent to such a process, method, item or device.

Although the embodiments of the present invention have been shown and described, it should be understood by those of ordinary skill in the art that various changes, modifications, substitutions and variations of theses embodiments may be made without departing from the principle and spirit of the present invention. The scope of the present invention is defined by the appended claims and equivalents thereof.

1. A depth video linkage feature-based behavior recognition method, comprising the following steps:
1) projecting a depth video of each behavior sample onto a front side, a right side, a left side and a top side to obtain corresponding projection sequences;
2) obtaining a dynamic image of each behavior sample by calculating a dynamic image of each projection sequence;
3) inputting the dynamic image of each behavior sample into a respective feature extraction module and extracting features;
4) inputting the extracted features into a multi-projection linkage feature extraction module and extracting a linkage feature of each projection combination;
5) connecting the extracted linkage features of all the projection combinations by channel, and inputting the connected features into an average pooling layer and a fully connected layer;
6) constructing a depth video linkage feature-based behavior recognition network;
7) inputting a depth video of each training behavior sample into the depth video linkage feature-based behavior recognition network, and training the network till convergence; and
8) inputting a depth video of each behavior sample to be tested into the trained behavior recognition network to implement behavior recognition.

2. The depth video linkage feature-based behavior recognition method according to claim 1, wherein the projection sequence is obtained in step 1) as follows:
acquiring a depth video of any behavior sample, each behavior sample consisting of all frames in the depth video of the behavior sample,
$$V = \{ {I}_{t} \vert t ∈ [ 1 , N ] \} ,$$
in which t represents a time index, and N is a total number of frames of the depth video V of the behavior sample; Iₜ∈R×C is a matrix representation of a t^{th}-frame depth image of the depth video V of the behavior sample, in which R and C correspond to the number of rows and the number of columns of the matrix representation of the t^{th}-frame depth image respectively, and indicates that a matrix is a real matrix; Iₜ(xᵢ, yᵢ)=dᵢ represents a depth value of a point pᵢ with coordinates (xᵢ, yᵢ) on the t^{th}-frame depth image, i.e., a distance between the point pᵢ and a depth camera; and dᵢ∈[0, D], in which D represents the furthest distance detectable by the depth camera;
the depth video V of the behavior sample is expressed as a set of projection sequences, which is denoted by a formula:
$$V = \{ {V}_{front} , {V}_{right} , {V}_{left} , {V}_{top} \} ,$$
in which V_{front} represents a projection sequence obtained by projecting the depth video V of the behavior sample onto a front side, V_{right} represents a projection sequence obtained by projecting the depth video V of the behavior sample onto a right side, V_{left} represents a projection sequence obtained by projecting the depth video V of the behavior sample onto a left side, and the Vₜₒₚ represents a projection sequence obtained by projecting the depth video V of the behavior sample onto a top side;
the projection sequence V_{front} is acquired as follows:
V_{front}={Fₜ|t∈[1, N]}, in which Fₜ∈R×C represents a projection graph obtained by projecting the t^{th}-frame depth image of the depth video V of the behavior sample onto the front side; an abscissa value xᵢ, an ordinate value yᵢ and a depth value dᵢ of the point pᵢ in the depth image respectively determine an abscissa value xᵢ^{ƒ}, an ordinate value yᵢ^{ƒ} and a pixel value zᵢ^{ƒ} of a point projected from the point pᵢ onto the projection graph Fₜ, which are denoted by formulas:
$${F}_{t} ( {x}_{i}^{f} , {y}_{i}^{f} ) = {z}_{i}^{f} ,$$
$${x}_{i}^{f} = {x}_{i} , {y}_{i}^{f} = {y}_{i} , {z}_{i}^{f} = {f}_{1} ( {d}_{i} ) ,$$
in which ƒ₁ is a linear function indicating that the depth value dᵢ is mapped to an interval [0,255], such that the smaller the depth value of a point is, the larger the pixel value of the point on the projection graph is, i.e., the closer the point is to the depth camera, the brighter the point is on a front-side projection graph;
the projection sequence V_{right} is acquired as follows:
V_{right}={Rₜ|t∈[1, N]}, in which Rₜ∈R×D represents a projection graph obtained by projecting the t^{th}-frame depth image on the right side; at least one point is projected onto the same location on the projection graph when the depth image is projected onto the right side; a point closest to an observer, i.e., a point furthest from a projection plane, is seen when a behavior is observed from the right side; an abscissa value of the point, furthest from the projection plane, on the depth image is reserved, and a pixel value of the point in this location of the projection graph is calculated according to the abscissa value; points in the depth image are traversed column by column from a column with the smallest abscissa x on the depth image in a direction in which x increases, and are projected onto the projection graph; an abscissa value xᵢ, an ordinate value yᵢ and a depth value dᵢ of the point pᵢ in the depth image respectively determine a pixel value zᵢ^{r}, an ordinate value yᵢ^{r} and an abscissa value xᵢ^{r} of a point in the projection graph Rₜ, which are denoted by formulas:
$${R}_{t} ( {x}_{i}^{r} , {y}_{i}^{r} ) = {z}_{i}^{r} ,$$
$${x}_{i}^{r} = {d}_{i} , {y}_{i}^{r} = {y}_{i} , {z}_{i}^{r} = {f}_{2} ( {x}_{i} ) ,$$
in which ƒ₂ is a linear function indicating that the abscissa value xᵢ is mapped to an interval [0,255]; in a case that x continues to increase, a new point is reserved if the new point and the previously projected point are projected onto the same location in the projection graph, i.e., a pixel value of this location in the projection graph is calculated by using the abscissa value of the point with the largest abscissa value, i.e., zᵢ^{r}=ƒ₂(xₘ), in which xₘ=max xᵢ, xᵢ∈X_{R}, X_{R} is a set of abscissas of all points with ordinate values yᵢ^{r} and depth values xᵢ^{r} in the depth image, and max xᵢ, xᵢ∈X_{R} represents a maximum abscissa value in the set X_{R};
the projection sequence V_{left} is acquired as follows:
V_{left}={Lₜ|t∈[1, N]}, in which Lₜ∈R×D represents a projection graph obtained by projecting the t^{th}-frame depth image onto the left side; in a case that multiple points are projected onto the same location on a left-side projection graph, a point furthest from a projection plane is reserved; points in the depth image are traversed column by column from a column with the largest abscissa x on the depth image in a direction in which x decreases, and are projected onto the left-side projection graph; an abscissa value xᵢ, an ordinate value yᵢ and a depth value dᵢ of the point pᵢ in the depth image respectively determine a pixel value zᵢ^{l}, an ordinate value yᵢ^{l} and an abscissa value xᵢ^{l} of a point in the projection graph Lₜ; for a point projected onto the same coordinates (xᵢ^{l}, yᵢ^{l}) on the left-side projection graph, an abscissa value of the point with the smallest abscissa is selected to calculate a pixel value at the coordinates of the projection graph, which is denoted by formulas:
$${L}_{t} ( {x}_{i}^{l} , {y}_{i}^{l} ) = {z}_{i}^{l} ,$$
$${x}_{i}^{l} = {d}_{i} , {y}_{i}^{l} = {y}_{i} , {z}_{i}^{l} = {f}_{3} ( {x}_{n} ) ,$$
in which ƒ₃ is a linear function indicating that an abscissa value xₙ is mapped to an interval [0,255]; xₙ=min xᵢ, xᵢ, ∈X_{L}, in which X_{L} is a set of abscisas of all points with ordinate values yᵢ^{l} and depth values xᵢ^{l} in the depth image, and min xᵢ,xᵢ∈X_{L} represents a minimum abscissa value in the set X_{L};
the projection sequence Vₜₒₚ is acquired as follows:
Vₜₒₚ={Tₜ|t∈[1, N]}, in which Oₜ∈D×C represents a projection graph obtained by projecting the t^{th}-frame depth image onto the top side; in a case that multiple points are projected onto the same location on a top-side projection graph, a point furthest from the projection plane is reserved; points in the depth image are traversed column by column from a column with the smallest ordinate y on the depth image in a direction in which y increases, and are projected onto the top-side projection graph; an abscissa value xᵢ, an ordinate value yᵢ and a depth value dᵢ of the point pᵢ in the depth image respectively determine an abscissa value xᵢ^{o}, a pixel value zᵢ^{o} and an ordinate value yᵢ^{o} of a point of the point pᵢ projected onto the projection graph Oₜ; for a point projected onto the same coordinates (xᵢ^{o}, yᵢ^{o}) on the projection graph, an ordinate value of the point with the largest ordinate is selected to calculate a pixel value at the coordinates of the projection graph, which is denoted by formulas:
$${O}_{t} ( {x}_{i}^{o} , {y}_{i}^{o} ) = {z}_{i}^{o} ,$$
$${x}_{i}^{o} = {x}_{i} , {y}_{i}^{o} = {d}_{i} , {z}_{i}^{o} = {f}_{4} ( {y}_{q} ) ,$$
in which ƒ₄ is a linear function indicating that an ordinate value y_{q} is mapped to an interval [0,255]; y_{q}=max yᵢ, yᵢ∈Yₒ in which Yₒ is a set of ordinates of all points with abscissa values xᵢ^{o} and depth values yᵢ^{o} in the depth image, and max yᵢ, yᵢ∈Yₒ represents a maximum ordinate value in the set Yₒ.

3. The depth video linkage feature-based behavior recognition method according to claim 1, wherein the dynamic image is calculated in step 2) as follows:
by taking a front-side projection sequence V_{front}={Fₜ∈[1, N]} of the depth video V of the behavior sample as an example, vectorizing Fₜ first, i.e., connecting a row vector of Fₜ into a new row vector iₜ;
solving an arithmetic square root of each element in the row vector iₜ to obtain a new vector wₜ, i.e.:
$${w}_{t} = \sqrt{{i}_{t}} ,$$
in which \sqrt{iₜ} indicates to solve an arithmetic square root of each element in the row vector iₜ, and wₜ is denoted by a frame vector of a t^{th}-frame image of the front-side projection sequence V_{front} of the depth video V of the behavior sample;
calculating a feature vector Vₜ of the t^{th}-frame image of the front-side projection sequence front of the depth video V of the behavior sample according to a formula:
$${v}_{t} = \frac{1}{t} {\sum }_{κ = 1}^{t} {w}_{κ} ,$$
in which Σ_{κ=1}^{t} w_{κ} represents summation of frame vectors from a first-frame image to the t^{th}-frame image of the front-side projection sequence V_{front} of the depth video V of the behavior sample;
calculating a score Bₜ of the t^{th}-frame image Fₜ of the front-side projection sequence V_{front} of the depth video V of the behavior sample according to a formula:
$${B}_{t} = {u}^{T} \cdot {v}_{t} ,$$
in which u is a vector of a dimension A, A=R×C, u^{T} represents transposition of the vector u, and u^{T}·vₜ indicates to calculate a dot product of the feature vector vₜ and a vector obtained by transposing the vector u;
calculating a value of u, such that frame images in the front-side projection sequence V_{front} have higher and higher scores from front to back, i.e., the larger the t is, the higher the score Bₜ is, u being calculated by using RankSVM as follows:
$$u = {arg min}_{u} E ( u ) ,$$
$$E ( u ) = \frac{λ}{2} {‖ u ‖}^{2} + \frac{2}{T ( T - 1 )} \times {\sum }_{c > j} max \{ 0 , 1 - {B}_{c} + {B}_{j} \} ,$$
in which
$${arg min}_{u} E ( u )$$
represents u that minimizes the value of E(u), λ is a constant, and ∥u∥² indicates to calculate a sum of squares of each element in the vector u; B_{c} and Bⱼ respectively represent a score of a c^{th}-frame image and a score of a j^{th}-frame image of the front-side projection sequence V_{front} of the depth video V of the behavior sample, and max{0,1−B_{c}+Bⱼ} indicates to choose a larger value of 0 and 1−B_{c}+Bⱼ; and
in response to calculating the vector u by using RankSVM, arranging the vector u in an image form with the same size as Fₜ to obtain u′∈R×C, u′ being a dynamic image of the front-side projection sequence V_{front} of the depth video V of the behavior sample.

4. The depth video linkage feature-based behavior recognition method according to claim 1, wherein the feature extraction module comprises a convolution unit 1, a convolution unit 2, a convolution unit 3, a convolution unit 4, a convolution unit 5 and a multi-feature fusion unit; wherein outputs of the convolution unit 1, the convolution unit 2, the convolution unit 3, the convolution unit 4 and the convolution unit 5 are sequentially inputted into the multi-feature fusion unit, and a final output of the multi-feature fusion unit is M₆;
the convolution unit 1 comprises two convolution layers and one maximum pooling layer, each convolution layer has 64 convolution kernels, each convolution kernel has a size of 3×3, a pooling kernel of the maximum pooling layer has a size of 2×2, and an output of the convolution unit 1 is C₁;
the convolution unit 2 comprises two convolution layers and one maximum pooling layer, each convolution layer has 128 convolution kernels, each convolution kernel has a size of 3×3, a pooling kernel of the maximum pooling layer has a size of 2×2, and an input of the convolution unit 2 is C₁ and an output thereof is C₂;
the convolution unit 3 comprises three convolution layers and one maximum pooling layer, each convolution layer has 256 convolution kernels, each convolution kernel has a size of 3×3, a pooling kernel of the maximum pooling layer has a size of 2×2, and an input of the convolution unit 3 is C₂ and an output thereof is C₃;
the convolution unit 4 comprises three convolution layers and one maximum pooling layer, each convolution layer has 512 convolution kernels, each convolution kernel has a size of 3×3, a pooling kernel of the maximum pooling layer has a size of 2×2, and an input of the convolution unit 4 is C₃ and an output thereof is C₄;
the convolution unit 5 comprises three convolution layers and one maximum pooling layer, each convolution layer has 512 convolution kernels, each convolution kernel has a size of 3×3, a pooling kernel of the maximum pooling layer has a size of 2×2, and an input of the convolution unit 5 is C₄ and an output thereof is C₅;
inputs of the multi-feature fusion unit are the output C₁ of the convolution unit 1, the output C₂ of the convolution unit 2, the output C₃ of the convolution unit 3, the output C₄ of the convolution unit 4 and the output C₅ of the convolution unit 5; the output C₁ of the convolution unit 1 is inputted into a maximum pooling layer 1 and a convolution layer 1 in the multi-feature fusion unit, a pooling kernel of the maximum pooling layer 1 has a size of 4×4, the convolution layer 1 has 512 convolution kernels, each convolution kernel has a size of 1×1, and an output of the convolution layer 1 is M₁;
the output C₂ of the convolution unit 2 is inputted into a maximum pooling layer 2 and a convolution layer 2 in the multi-feature fusion unit, a pooling kernel of the maximum pooling layer 2 has a size of 2×2, the convolution layer 2 has 512 convolution kernels, each convolution kernel has a size of 1×1, and an output of the convolution layer 2 is M₂;
the output C₃ of the convolution unit 3 is inputted into a convolution layer 3 in the multi-feature fusion unit, the convolution layer 3 has 512 convolution kernels, each convolution kernel has a size of 1×1, and an output of the convolution layer 3 is M₃;
the output C₄ of the convolution unit 4 is inputted into an up-sampling layer 1 and a convolution layer 4 in the multi-feature fusion unit, the convolution layer 4 has 512 convolution kernels, each convolution kernel has a size of 1×1, and an output of the convolution layer 4 is M₄;
the output C₅ of the convolution unit 5 is inputted into an up-sampling layer 2 and a convolution layer 5 in the multi-feature fusion unit, the convolution layer 5 has 512 convolution kernels, each convolution kernel has a size of 1×1, and an output of the convolution layer 5 is M₅; the output M₁ of the convolution layer 1, the output M₂ of the convolution layer 2, the output M₃ of the convolution layer 3, the output M₄ of the convolution layer 4 and the output M₅ of the convolution layer 5 are connected by channel and inputted into a convolution layer 6; the convolution layer 6 has 256 convolution kernels, each convolution kernel has a size of 1×1, an output of the convolution layer 6 is M₆, and an output of the multi-feature fusion unit is the output M₆ of the convolution layer 6;
dynamic images of the front-side projection sequence, the right-side projection sequence, the left-side projection sequence and the top-side projection sequence of the depth video V of the behavior sample are respectively inputted into respective feature extraction modules, namely, a front-side projection feature extraction module, a right-side projection feature extraction module, a left-side projection feature extraction module and a top-side projection feature extraction module, and during network training, the modules described above do not share parameters, and the feature extraction modules described above respectively output features Q^{ƒ}, Q^{r}, Q^{l} and Q^{t};
Q^{ƒ} represents a feature that is extracted when the dynamic image of the front-side projection sequence of the depth video V of the behavior sample is inputted into the front-side projection feature extraction module, Q^{r} represents a feature that is extracted when the dynamic image of the right-side projection sequence of the depth video V of the behavior sample is inputted into the right-side projection feature extraction module, Q^{l} represents a feature that is extracted when the dynamic image of the left-side projection sequence of the depth video V of the behavior sample is inputted into the left-side projection feature extraction module, and Q^{t} represents a feature that is extracted when the dynamic image of the top-side projection sequence of the depth video V of the behavior sample is inputted into the top-side projection feature extraction module.

5. The depth video linkage feature-based behavior recognition method according to claim 1, wherein the linkage feature is extracted in step 4) by combining every two, every three and every four of the features extracted by each feature extraction module in step 3) to obtain multiple projection combinations;
a linkage feature of each projection combination is calculated as follows:
connecting the features in the projection combination by channel to obtain a combined feature Q∈H×W×γJ, in which H and W represent a height and a width of each feature in the projection combination respectively, J represents the number of channels of each feature in the projection combination, and γ represents the number of features in the projection combination; calculating an explicit linkage feature Z_{α} of each projection combination and an implicit linkage feature Z_{β} of each projection combination; and calculating a linkage feature Z of the projection combination according to a formula:
$$Z = {Z}_{α} ⊕ {Z}_{β} ,$$
in which ⊕ represents addition of elements in corresponding positions of matrices Z_{α} and Z_{β}.

6. The depth video linkage feature-based behavior recognition method according to claim 1, wherein in step 5), the linkage features of all the projection combinations are connected by channel, and inputted into the average pooling layer, an output Γ of the average pooling layer is inputted into the fully connected layer 2, the quantity of neurons in the fully connected layer 2 is D₂, and an output S₂ of the fully connected layer 2 is calculated as follows:
$${S}_{2} = {ϕ}_{r e l u} ( {W}_{2} \cdot Γ + {θ}_{2} ) ,$$
in which ϕᵣₑₗᵤ is an activation function relu, W₂ is a weight of the fully connected layer 2, and θ₂ is a bias vector of the fully connected layer 2;
the output S₂ of the fully connected layer 2 is inputted into a fully connected layer 3 with an activation function softmax, the quantity of neurons in the fully connected layer 3 is K, and an output S₃ is calculated as follows:
$${S}_{3} = {ϕ}_{softmax} ( {W}_{3} \cdot {S}_{2} + {θ}_{3} ) ,$$
in which ϕ_{softmax} represents the activation function softmax, W₃ is a weight of the fully connected layer 3, and θ₃ is a bias vector of the fully connected layer 3.

7. The depth video linkage feature-based behavior recognition method according to claim 1, wherein an input of the depth video linkage feature-based behavior recognition network in step 6) is the depth video of the behavior sample, an output thereof is a probability that a corresponding behavior sample belongs to the respective behavior category, i.e., the output Q₃ of the fully connected layer 3, and a loss function L of the network is:
$$L = - {\sum }_{g = 1}^{G} {\sum }_{p = 1}^{K} {[ {l}_{g} ]}_{p} log ( {[ {Q}_{3}^{g} ]}_{p} ) ,$$
in which G is a total quantity of training behavior samples, K is the quantity of categories of behavior samples, Q₃^{g} is a network output of a g^{th} behavior sample, l_{g} is an expected output of the g^{th} behavior sample, and p^{th}-dimension data of l_{g} is defined as:
$${[ {l}_{g} ]}_{p} = \{ \begin{matrix}1 , & if p = {l}_{g} \\ 0 , & else\end{matrix} ,$$
in which l_{g} is a tag value of the g^{th} behavior sample.

8. The depth video linkage feature-based behavior recognition method according to claim 1, wherein the behavior recognition in step 8) comprises: inputting a depth video of each tested behavior sample into the trained depth video linkage feature-based behavior recognition network to obtain a predicted probability value of a current tested behavior video sample belonging to the respective behavior category, and taking the behavior category with the largest probability value as the finally predicted behavior category to which the current tested behavior video sample belongs, so as to implement the behavior recognition.

9. The depth video linkage feature-based behavior recognition method according to claim 5, wherein the explicit linkage feature of each projection combination is calculated by the following steps:
1) calculating an average value of features of each channel and an average value Q̅ₐ of features of an a^{th} channel of the combined feature Q according to a formula:
$${\overline{Q}}_{a} = \frac{1}{H \times W} {\sum }_{h , w}^{H , W} {Q}_{a , h , w} ,$$
in which Q_{a,h,w} represents an h^{th}-row and w^{th}-column element value of the a^{th} channel of the combined feature Q;
2) calculating a degree of explicit correlation P∈γJ×γJ of features between different channels of the combined feature Q, a degree of explicit correlation P^{a,b} of features between the a^{th} channel and a b^{th} channel being calculated according to a formula:
$${P}^{a , b} = \frac{1}{H \times W} {\sum }_{h , w}^{H , W} ( {Q}_{a , h , w} - {\overline{Q}}_{a} ) ( {Q}_{b , h , w} - {\overline{Q}}_{b} ) ,$$
in which Q_{b,h,w} represents an h^{th}-row and w^{th}-column element value of the b^{th} channel of the combined feature Q, and Q̅_{b} represents an average value of features of the b^{th} channel of the combined feature Q;
3) calculating a degree of normalized explicit correlation \hat{P}∈γJ×γJ of features between the different channels of the combined feature Q, a degree of normalized explicit correlation \hat{p}^{a,b} of features between the a^{th} channel and the b^{th} channel being calculated according to a formula:
$${\hat{P}}^{a , b} = \frac{{e}^{{P}^{a , b}}}{{\sum }_{b = 1}^{γ J} {e}^{{P}^{a , b}}} ;$$
and
4) calculating an explicit linkage feature Z_{α}∈H×W×γJ of the projection combination, a feature Z_{α}^{a} of the a^{th} channel of Z_{α} being calculated according to a formula:
$${Z}_{α}^{a} = {\sum }_{b = 1}^{γ J} {\hat{P}}^{a , b} {Q}_{b} ,$$
in which Q_{b} represents a feature of the b^{th} channel of the combined feature Q.

10. The depth video linkage feature-based behavior recognition method according to claim 5, wherein the implicit linkage feature of each projection combination is calculated by the following steps:
1) calculating an average value of each channel of the combined feature Q, and connecting the average values of all the channels into a vector Q̅=(Q̅₁,Q̅₂, . . . , Q̅_{γJ});
2) inputting the vector Q̅ into the fully connected layer 1, the number of neurons of the fully connected layer 1 being γJ, an output of the fully connected layer 1 being S₁=ϕ_{sigmoid}(W₁·Q̅+θ₁)∈ [symbol] , in which ϕ_{sigmoid} represents an activation function sigmoid, W₁∈γJ×γJ represents a weight of the fully connected layer 1, and θ₁∈ [symbol] represents a bias vector of the fully connected layer 1; and
3) calculating an implicit linkage feature Z_{β}∈H×W×γJ of the projection combination, a feature Z_{β}^{a} of an a^{th} channel of Z_{β} being calculated according to a formula:
$${Z}_{β}^{a} = {S}_{1}^{a} \cdot {Q}_{a} ,$$
in which S₁^{a} represents a value of an a^{th} element of the output S₁ of the fully connected layer 1.
